(19) United States
(12) Patent Application Publication
(10) Pub. No.: US 2013/0293707 A1
(43) Pub. Date: Nov. 7, 2013

(54) SYSTEMS AND METHODS FOR ALLOWING USERS TO READ ELECTRONIC BOOKS FROM PAGES LAST VIEWED IN CORRESPONDING PHYSICAL BOOKS

(71) Applicant: Yat Wai Edwin Kwong, Causeway Bay (HK)

(72) Inventor: Yat Wai Edwin Kwong, Causeway Bay (HK)

(21) Appl. No.: 13/464,157

(22) Filed: May 4, 2012

(51) Int. Cl. H04N 7/18; G06K 7/01

(52) U.S. Cl. 348/143; 340/10.6; 348/E07.085

(57) ABSTRACT

A dual book management system and method are provided for synchronizing physical books in a bookshelf, to electronic books (“ebooks”) in an electronic bookshelf (“ebookshelf”). The system generally employs radio frequency identification (“rfid”) technology to electronically detect positions of books of the physical bookshelf, as well as last viewed pages of each individual book. The components of the disclosed systems and methods include an electronic device with rfid reader placed near a bookshelf, a mobile device for viewing ebooks, rfid tags included in each book, a processor and memory. The systems and methods may also employ rfid-enabled bookmarks as well as OCR-enabled cameras.

### FIELD OF THE INVENTION

This invention is generally related to electronic book management. More specifically, this invention is related to allowing users to read ebooks from pages last seen in corresponding physical books.

### BACKGROUND OF THE INVENTION

Physical books are becoming increasingly less popular. Physical books are heavy, especially those published for education purposes. Many of which can have a few hundred and even thousands of pages. These heavy books can become a burden to readers who travel to and from class or work. Students, for example, would find physical books particularly inconvenient, as they need to frequently bring them to school on a daily basis. In the students' situation, carrying a load of physical books, rather than just a single book, can be even more burdensome.

Therefore, electronic books (“ebooks”) can be a solution for the traditional physical book readers. However, asking these traditional readers to change all of their reading behavior to electronic books immediately can be difficult. Therefore, having an intermediate solution may be vital for transition purposes. So, at home or at office, a traditional reader would likely read a book taken from his or her bookshelf. However, when left home or office, the user would find it convenient and handy to read the corresponding book on a mobile or handheld device. However, it can be cumbersome if the user must flip pages of the electronic book to the page where the user last read the physical book. Therefore, it would be ideal if there was a solution that allows a user to open an electronic book to the right page.

As a result, in view of the foregoing, there is a need unfulfilled in the art for systems and methods that serve facilitate the transition from physical books to electronic books.

### SUMMARY OF THE INVENTION

According to embodiments of the invention, a system and method for allowing users to read electronic books (herein “ebooks”) from pages last viewed in corresponding physical books is provided. The dual book management system employs the following components: an electronic device place near a bookshelf, a mobile device for displaying ebooks, a radio frequency identification (herein “rfid”) included in each physical book in the bookshelf, an rfid reader included in the electronic device, a processor, and memory.

The memory comprises instructions that cause the processor to execute a method which comprises the following steps. The first step involves displaying an electronic bookshelf (herein “ebookshelf”) with ebooks on the mobile device. The ebookshelf and the ebooks correspond to the physical bookshelf and books. The second step involves synchronizing the ebookshelf and the physical bookshelf by detecting changes in position of the books on the physical bookshelf using the rfid reader.

The next step involves detecting that a physical book is being read by the user and then detecting when the user has temporarily stopped reading the physical book. At this point, a page number is detected corresponding to a last page viewed by the user before stopping reading.

The method proceeds highlighting an ebook from the ebookshelf on the mobile device. The ebook corresponds to the physical book that was last viewed by the user. The highlighted ebook is opened upon instruction by the user. When opened, the last viewed page of the physical book is automatically displayed in the ebook.

In embodiments of the disclosed system, the system may further comprise a camera associated with the electronic device. The camera is configured to capture page numbers of the physical books. The step of detecting a page number corresponding to a last page viewed employs detection of the page number using the camera.

In still further embodiments of the disclosed system, the dual book management system may also comprise a bookmark associated with each physical book. The bookmark comprising an rfid tag. In this embodiment, the step of detecting a page number employs detection of the bookmarks placement in the book when the user is done reading the book.

In another embodiment of the disclosed technology, a dual book management system for facilitating users to read ebooks from pages last viewed from corresponding physical books is provided. The dual book management system employs the following components: an electronic device place near a bookshelf, a mobile device for displaying ebooks, a camera associated with the electronic device, a radio frequency identification (herein “rfid”) included in each physical book in the bookshelf, an rfid reader included in the electronic device, a processor, and memory. The camera is configured to capture page numbers of the physical books.

The memory comprises instructions that cause the processor to execute a method which comprises the following steps. The first step involves displaying an electronic bookshelf (herein “ebookshelf”) with ebooks on the mobile device. The ebookshelf and the ebooks correspond to the physical bookshelf and books. The second step involves maintaining reciprocity between the ebookshelf and physical bookshelf by detecting changes in position of the books of the physical bookshelf using the rfid reader.

The next step involves detecting that a physical book is being read by the user and then detecting when the user has temporarily stopped reading the physical book. At this point, a page number is detected corresponding to a last page viewed by the user before stopping reading.

The method proceeds highlighting an ebook from the ebookshelf on the mobile device. The ebook corresponds to the physical book that was last viewed by the user. The highlighted ebook is opened upon instruction by the user. When opened, the last viewed page of the physical book is automatically displayed in the ebook.

In still another embodiment of the disclosed technology, method for synchronizing physical books in a bookshelf to electronic books stored electronically is provided. The method comprises a number of steps. The method begins by providing an electronic rfid reader placed on or around a bookshelf. The bookshelf contains physical books. Each of the physical books has a unique rfid tag. The second step involves capturing, using a camera associated with the rfid reader, a page number corresponding to a last viewed page of a particular physical book.

Next, the rfid reader detects when the particular book has been placed on the bookshelf. At this point, the method proceeds by accentuating, on a mobile device, an electronic version of the particular physical book placed on the bookshelf. Finally, the ends by selectively displaying an electronic page of the electronic version of the particular physical book. The electronic page corresponds to the last page viewed on the particular physical book.

In a further embodiment of the disclosed method, the step of capturing a page number corresponding to a last viewed page further comprises confirming the page number corresponding to the last viewed page by detecting, using the rfid reader, a placement of a bookmark in the particular physical book. The bookmark comprises an additional rfid tag.

In an alternative embodiment of the disclosed method, each unique rfid is stored in a bookmark that is stored in each of the physical books. In this embodiment, an additional step may be provided after the step of capturing a page number corresponding to a last viewed page. The additional step involving confirming the page number corresponding to the last viewed page by detecting, using the rfid reader, a placement of the bookmark in the particular physical book.

In accordance with these and other objects which will become apparent hereinafter, the invention will now be described with particular reference to the drawing.

### BRIEF DESCRIPTION OF THE DRAWINGS

FIG. 1 shows a block diagram of a book management system according to embodiments of the disclosed invention.

FIG. 2 shows a flow chart of a method of managing books according to embodiments of the disclosed invention.

### DETAILED DESCRIPTION

According to embodiments of the invention, a dual book management system and method are provided for synchronizing physical books in a bookshelf, to electronic books (herein “ebooks”) in an electronic bookshelf (herein “ebookshelf”). The system generally employs radio frequency identification (herein “rfid”) technology to electronically detect positions of books of the physical bookshelf, as well as last viewed pages of each individual book. The components of the disclosed systems and methods include an electronic device with rfid reader placed near a bookshelf, a mobile device for viewing ebooks, rfid tags included in each book, a processor and memory. The systems and methods may also employ rfid-enabled bookmarks as well as OCR-enabled cameras.

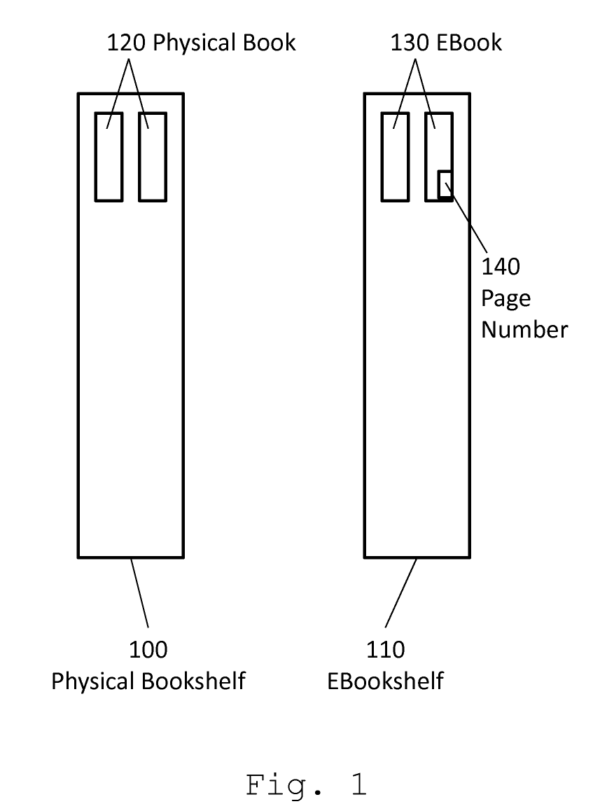

Referring now to the drawings, FIG. 1 shows a block diagram of a book management system according to embodiments of the disclosed invention. A physical bookshelf 100 and ebookshelf 110 are shown. The ebookshelf 110 would be electronically displayed on a mobile device. The mobile device may be a tablet PC, e-reader, mobile phone, or any other portable electronic device. Physical books 120 in the physical bookshelf correspond to ebooks 130 in the ebookshelf 110. Each ebook 140 capable of being opened to a particular page with corresponding page number 140. The page number 140 being the electronic version of the last viewed page of a corresponding physical book 120.

The dual book management system employs the following components: an electronic device place near a bookshelf, a mobile device for displaying ebooks, a radio frequency identification (herein “rfid”) included in each physical book in the bookshelf, an rfid reader included in the electronic device, a processor, and memory.

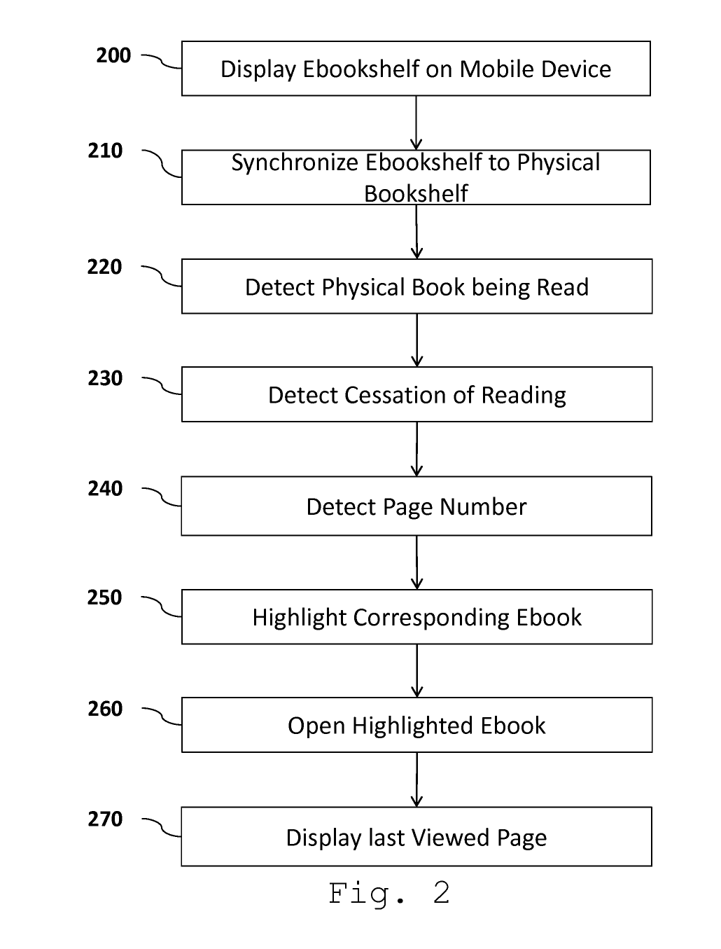

FIG. 2 shows a flow chart of a method of managing books according to embodiments of the disclosed invention. The steps of the method are stored in the memory and executed by the processor. The first step 200 involves displaying an electronic bookshelf (herein “ebookshelf”) with ebooks on the mobile device. The ebookshelf and the ebooks correspond to the physical bookshelf and books. The second step 210 involves synchronizing the ebookshelf and the physical bookshelf by detecting changes in position of the books on the physical bookshelf using the rfid reader.

The next step 220 involves detecting that a physical book is being read by the user. The method proceeds in step 230 by detecting when the user has temporarily stopped reading the physical book. At this point 240, a page number is detected corresponding to a last page viewed by the user before stopping reading.

The method proceeds in step 250 by highlighting an ebook from the ebookshelf on the mobile device. The ebook corresponds to the physical book that was last viewed by the user. In step 260 the highlighted ebook is opened upon instruction by the user. Finally, in step 270, When the ebook is opened, the last viewed page of the physical book is automatically displayed.

In embodiments of the disclosed system, the system may further comprise a camera associated with the electronic device. The camera is configured to capture page numbers of the physical books. The step of detecting a page number corresponding to a last page viewed employs detection of the page number using the camera.

In still further embodiments of the disclosed system, the dual book management system may also comprise a bookmark associated with each physical book. The bookmark comprising an rfid tag. In this embodiment, the step of detecting a page number employs detection of the bookmarks placement in the book when the user is done reading the book.

Radio frequency identification (“rfid”) tagging is a known method of identification. An information carrying device, or receiver, functions in response to a coded radio frequency (herein “RF”) signal transmitted from a base station or reader. The RF carrier signal reflects from the receiver and can be demodulated to recover information stored in the receiver. The receiver typically includes a semiconductor chip having RF circuits, logic, and memory, as well as an antenna. Various receiver structures, circuits, and programming protocols are known in the art.

RF systems typically have three components: (1) a tag or receiver (the item being identified), (2) an interrogator or reader, and (3) a data managing medium (typically including cabling, computers, and software which tie together the tags and interrogators into a useful solution). RF products are typically designed to detect receivers when they pass within a predefined range of the reader.

There are generally two types of RF receivers known in the art: passive RF receivers and active RF receivers. Passive RF receivers, unlike active ones, do not require a battery in order to transmit a RF signal frequency. Instead, passive RF receivers rely on an external source to provoke signal transmission. The RF reader transmits the operating power for these receivers. As a result, such passive RF systems generally have a detection range of limited to a couple meters. However, passive RF receivers may generally be manufactured to be smaller in size than active RF receivers due to the absence of a battery.

Most passive rfid systems work as follows. A reader emits an electromagnetic field for the purpose of powering the receiver. A coil in the receiver is powered by the electromagnetic field, causing the receiver's circuitry to “wake up.” The receiver uses this power to send an identifying signal back to the interrogator. Either type of rfid tag may be employed by the present technology.

In another embodiment of the disclosed technology, a dual book management system for facilitating users to read ebooks from pages last viewed from corresponding physical books is provided. The dual book management system employs the following components: an electronic device place near a bookshelf, a mobile device for displaying ebooks, a camera associated with the electronic device, a radio frequency identification included in each physical book in the bookshelf, an rfid reader included in the electronic device, a processor, and memory. The camera is configured to capture page numbers of the physical books.

The memory comprises instructions that cause the processor to execute a method which comprises the following steps. The first step involves displaying an electronic bookshelf (herein “ebookshelf”) with ebooks on the mobile device. The ebookshelf and the ebooks correspond to the physical bookshelf and books. The second step involves maintaining reciprocity between the ebookshelf and physical bookshelf by detecting changes in position of the books of the physical bookshelf using the rfid reader.

The next step involves detecting that a physical book is being read by the user and then detecting when the user has temporarily stopped reading the physical book. At this point, a page number is detected corresponding to a last page viewed by the user before stopping reading.

The method proceeds highlighting an ebook from the ebookshelf on the mobile device. The ebook corresponds to the physical book that was last viewed by the user. The highlighted ebook is opened upon instruction by the user. When opened, the last viewed page of the physical book is automatically displayed in the ebook.

In still another embodiment of the disclosed technology, method for synchronizing physical books in a bookshelf to electronic books stored electronically is provided. The method comprises a number of steps. The method begins by providing an electronic rfid reader placed on or around a bookshelf. The bookshelf contains physical books. Each of the physical books has a unique rfid tag. The second step involves capturing, using a camera associated with the rfid reader, a page number corresponding to a last viewed page of a particular physical book.

Next, the rfid reader detects when the particular book has been placed on the bookshelf. At this point, the method proceeds by accentuating, on a mobile device, an electronic version of the particular physical book placed on the bookshelf. Finally, the ends by selectively displaying an electronic page of the electronic version of the particular physical book. The electronic page corresponds to the last page viewed on the particular physical book.

In a further embodiment of the disclosed method, the step of capturing a page number corresponding to a last viewed page further comprises confirming the page number corresponding to the last viewed page by detecting, using the rfid reader, a placement of a bookmark in the particular physical book. The bookmark comprises an additional rfid tag.

In an alternative embodiment of the disclosed method, each unique rfid is stored in a bookmark that is stored in each of the physical books. In this embodiment, an additional step may be provided after the step of capturing a page number corresponding to a last viewed page. The additional step involving confirming the page number corresponding to the last viewed page by detecting, using the rfid reader, a placement of the bookmark in the particular physical book.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A dual book management system to facilitate reading of ebooks from pages last viewed from corresponding physical books, comprising:
an electronic device placed near a bookshelf, wherein the bookshelf comprises physical books;
a mobile device configured to display ebooks that correspond to the physical books;
an rfid tag included in each physical book;
an rfid reader included in the electronic device;
a processor; and
a memory storing instructions that cause the processor to execute a method, the method comprising the following steps:
displaying an ebookshelf with ebooks on the mobile device, wherein the ebookshelf and the ebooks correspond to the physical bookshelf and books;
synchronizing the ebookshelf and the physical bookshelf by detecting changes in position of the books on the physical bookshelf using the rfid reader;
detecting that a physical book is being read by a user;
detecting that the user has temporarily stopped reading the physical book;
detecting a page number corresponding to a last page viewed by the user before closing the book;
highlighting an ebook from the ebookshelf on the mobile device, wherein the ebook corresponds to the physical book that was last viewed by the user;
opening the highlighted ebook upon instruction by the user; and
automatically displaying in the ebook the last page viewed by the user in the physical book.

2. The dual book management system of claim 1, further comprising:
a camera associated with the electronic device, the camera configured to capture page numbers of the physical books.

3. The dual book management system of claim 2, wherein the step detecting a page number corresponding to a last page viewed employs detection of the page number using the camera.

4. The dual book management system of claim 1, further comprising:
a bookmark associated with each physical book, the bookmark comprising an rfid tag.

5. The dual book management system of claim 4, wherein the step detecting a page number corresponding to a last page viewed employs detection of a placement of the bookmark in the book.

6. A dual book management system to facilitate reading of ebooks from pages last viewed from corresponding physical books, comprising:
an electronic device placed near a bookshelf, wherein the bookshelf comprises the physical books;
a mobile device configured to display ebooks that correspond to the physical books;
a camera associated with the electronic device, the camera configured to capture page numbers of the physical books;
an rfid tag included in each physical book;
an rfid reader included in the electronic device;
a processor; and
a memory storing instructions that cause the processor to execute a method, the method comprising the following steps:
displaying an ebookshelf with ebooks on the mobile device, wherein the ebookshelf and the ebooks correspond to the physical bookshelf and books;
maintaining synchronization of the ebookshelf and physical bookshelf by detecting changes in position of the books on the physical bookshelf using the rfid reader;
detecting that a physical book is being read by the user;
detecting that the user has temporarily stopped reading the physical book;
detecting a page number corresponding to a last page viewed by the user before stopping reading;
highlighting an ebook from the ebookshelf on the mobile device, wherein the ebook corresponds to the physical book that was last read by the user;
opening the highlighted ebook upon instruction by the user; and
automatically displaying in the ebook the last page viewed by the user in the physical book.

7. A method for synchronizing physical books in a bookshelf to electronic books (“ebooks”) stored electronically, the method comprising the following steps:
providing an electronic rfid reader placed on or around a bookshelf, wherein the bookshelf comprises physical books, each physical book comprising a unique rfid tag;
capturing, using a camera associated with the rfid reader, a page number corresponding to a last viewed page of a particular physical book;
detecting, with the rfid reader, when the particular physical book has been placed on the bookshelf;
accentuating, on a mobile device, an electronic version of the particular physical book placed on the bookshelf; and
selectively displaying an electronic page of the electronic version of the particular physical book, the electronic page corresponding to the last page viewed on the particular physical book.

8. The method of claim 7, wherein the step of capturing a page number corresponding to a last viewed page further comprises:
confirming the page number corresponding to the last viewed page by detecting, using the rfid reader, a placement of a bookmark in the particular physical book; the bookmark comprising an additional rfid tag.

9. The method of claim 7, wherein each unique rfid tag is stored in a bookmark that is associated with each of the physical books.

10. The method of claim 8, further comprising an additional step after the step of capturing a page number corresponding to a last viewed page, the additional step comprising:
confirming the page number corresponding to the last viewed page by detecting, using the rfid reader, a placement of the bookmark in the particular physical book.
